(19) United States
(12) Patent Application Publication
(10) Pub. No.: US 2015/0162619 A1
(43) Pub. Date: Jun. 11, 2015

(54) ELECTRODE CATALYST, METHOD FOR PREPARING SAME, AND MEMBRANE ELECTRODE ASSEMBLY AND FUEL CELL INCLUDING SAME

(71) Applicants: SNU R&DB Foundation, Seoul (KR); Global Frontier Center for Multiscale Energy Systems, Seoul (KR)

(72) Inventors: Sang Moon Kim, Gyeonggi-do (KR); Namgee Jung, Seoul (KR); Kahp-Yang Suh, Seoul (KR); Yung-Eun Sung, Seoul (KR); Man Soo Choi, Seoul (KR)

(21) Appl. No.: 14/351,490

(22) PCT Filed: Oct. 24, 2013
(86) PCT No.: PCT/KR2013/009544

§ 371 Date: Apr. 11, 2014

(51) Int. Cl. H01M 4/90; H01M 4/92; H01M 8/10; H01M 4/88

(52) U.S. Cl. CPC H01M 4/9008; H01M 4/8878; H01M 4/926; H01M 8/1004; H01M 4/9083; H01M 2008/1095; H01M 2300/0082

(57) ABSTRACT

The present invention relates to an electrode catalyst, a method for preparing the electrode catalyst, and a membrane electrode assembly and a fuel cell including the electrode catalyst. The electrode catalyst includes a carbon support and a platinum catalyst supported on the carbon support. A thermally responsive polymer is selectively bound to the carbon support. The electrode catalyst can ensure smooth discharge of water produced as a result of an electrochemical reaction, achieving improved electrical performance of the fuel cell.

### TECHNICAL FIELD

The present invention relates to an electrode catalyst that can ensure smooth discharge of water produced as a result of an electrochemical reaction, a method for preparing the electrode catalyst, and a membrane electrode assembly and a fuel cell including the electrode catalyst.

### BACKGROUND ART

Fuel cells have been the subject of intense interest as alternative energy sources. Fuel cells can be classified into polymer electrolyte membrane fuel cells (PEMFCs), direct methanol fuel cells (DMFCs), phosphoric acid fuel cells (PAFCs), molten carbonate fuel cells (MCFCs), and solid oxide fuel cells (SOFCs) depending on the kind of the electrolyte and fuel employed.

In a hydrogen-fueled fuel cell, such as a polymer electrolyte membrane fuel cell, hydrogen gas injected into an anode electrochemically reacts with oxygen gas (or air) injected into a cathode to generate DC electricity, water, and heat. At this time, the water produced in the cathode surrounds a catalyst to impair the activity of the catalyst. This phenomenon is called “flooding.” Flooding reduces the active area of the catalyst and impedes the diffusion of oxygen and the electrochemical reaction, leading to deterioration of the fuel cell performance.

In an attempt to efficiently discharge water produced as a result of an electrochemical reaction in a fuel cell electrode, hydrophobic microparticles, together with platinum/carbon (Pt/C) catalyst particles, are dispersed in a catalyst layer. The hydrophobic microparticles effectively function to bring about an increase in the amount of water discharged. However, some of the hydrophobic microparticles incapable of selective adsorption are adsorbed to the catalyst surfaces, resulting in a reduction in the active area of the catalyst. Furthermore, dispersion of the hydrophobic microparticles in a larger amount than necessary is liable to deteriorate the performance of the fuel cell.

As an alternative approach for water discharge, an attempt has been made to increase the porosity of a catalyst layer. Specifically, pore formers, together with Pt/C catalyst particles, are dispersed in the catalyst layer, and thereafter, only the pore formers are selectively removed to increase the porosity of the catalyst layer. An increased amount of water is effectively discharged through the catalyst layer, but at the same time, the thickness of the catalyst layer increases with increasing porosity, deteriorating the diffusion of oxygen gas and causing poor mechanical stiffness of the catalyst layer.

### DISCLOSURE

### Technical Problem

It is an object of the present invention to provide an electrode catalyst that can ensure smooth discharge of water produced in an electrode of a fuel cell without losing the catalyst's activity and gas diffusion performance, achieving improved electrical performance of the fuel cell.

It is a further object of the present invention to provide a method for preparing the electrode catalyst.

It is another object of the present invention to provide a membrane electrode assembly including the electrode catalyst.

It is still another object of the present invention to provide a fuel cell including the membrane electrode assembly.

### Technical Solution

One aspect of the present invention provides an electrode catalyst including a carbon support and a metal catalyst supported on the carbon support wherein a thermally responsive polymer is selectively bound to the carbon support.

According to one embodiment, the thermally responsive polymer becomes hydrophobic at or above a predetermined temperature and becomes hydrophilic at or below the predetermined temperature.

According to one embodiment, the thermally responsive polymer may include a repeating unit of Formula 1:

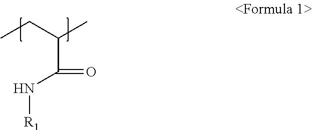

wherein R₁ represents a hydrogen atom, a halogen atom, a carboxyl group, a hydroxyl group, a substituted or unsubstituted C₁-C₂₀ alkyl group, a substituted or unsubstituted C₆-C₃₀ aryl group, a substituted or unsubstituted C₁-C₂₀heteroalkyl group, a substituted or unsubstituted C₅-C₃₀heteroaryl group, or a substituted or unsubstituted C₇-C₃₀arylalkyl group.

According to one embodiment, the thermally responsive polymer may include the repeating unit of Formula 2:

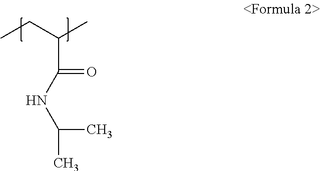

According to one embodiment, the thermally responsive polymer is poly(N-isopropylacrylamide) of Formula 3:

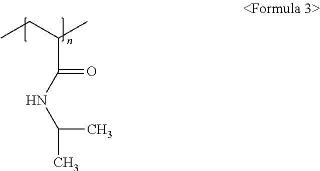

wherein n is a number from 10 to 100,000.

A further aspect of the present invention provides a method for preparing an electrode catalyst for a fuel cell, which includes the step of mixing a thermally responsive amine-terminated polymer with a platinum-based catalyst supported on a carbon support in an acidic solution, and reacting the carbon support with the thermally responsive polymer in the presence of a catalyst to form an amide bond.

Another aspect of the present invention provides a membrane electrode assembly including a cathode, an anode arranged opposite the cathode, and an electrolyte membrane arranged between the cathode and the anode wherein the cathode includes the electrode catalyst.

Yet another aspect of the present invention provides a fuel cell including the membrane electrode assembly.

According to one embodiment, the thermally responsive polymer included in the membrane electrode assembly becomes hydrophobic at an operating temperature of the fuel cell and becomes hydrophilic at a non-operating temperature of the fuel cell.

### Advantageous Effects

The electrode catalyst of the present invention is prepared by chemically binding a thermally responsive polymer only to the surface of a carbon support. The use of the electrode catalyst promotes the migration of water produced in the cathode when the fuel cell is operated, leading to an improvement in the electrical performance of the fuel cell.

Due to the selective binding between the carbon support and the thermally responsive polymer, the electrode catalyst of the present invention is free from loss of active surface area, which is a problem in conventional electrode catalysts based on non-selective adsorption. The electrode catalyst of the present invention does not substantially affect the thickness of a catalyst layer, avoiding problems associated with gas diffusion and mechanical stiffness.

A hydrophilic alcoholic solvent is generally used to induce uniform dispersion of a catalyst and a Nafion ionomer during catalyst ink preparation. In contrast, the electrode catalyst of the present invention prepared by selective binding between the thermally responsive polymer and the carbon support is hydrophilic at room temperature, and therefore, its degree of dispersion in a catalyst ink can be kept sufficiently uniform even without the use of a hydrophilic alcoholic solvent.

The electrode catalyst of the present invention can be utilized in various industrial applications, including proton electrolyte membrane fuel cells (PEMFCs) and direct methanol fuel cells (DMFCs). Furthermore, the electrode catalyst of the present invention can find applications in other energy technologies, including energy systems that suffer from performance deterioration resulting from water discharge.

### DESCRIPTION OF DRAWINGS

FIG. 1 is a schematic diagram showing an operating mechanism of a fuel cell according to the prior art.

FIG. 2 is a schematic diagram showing the formation of bonds between a carbon support and a thermally responsive polymer.

FIG. 3 is a perspective view illustrating the structure of a fuel cell according to one embodiment of the present invention.

FIG. 4 is a cross-sectional view of a membrane electrode assembly according to one embodiment of the present invention.

FIG. 5 shows photoelectron spectra of a fuel cell catalyst powder prepared in Example 1 and a conventional Pt/C catalyst.

FIG. 6 shows cyclic voltammograms (CV) of cathode catalyst layers obtained in Example 2 and Comparative Example 1;

FIG. 7 is a scanning electron microscopy (SEM) image of a catalyst layer obtained in Comparative Example 1.

FIG. 8 is a SEM image of a catalyst layer obtained in Example 2.

FIG. 9 is a graph showing differences between the power densities of a membrane electrode assembly obtained in Example 2 depending on the cell temperatures.

FIG. 10 is a graph showing the potentials of membrane electrode assemblies obtained in Example 2 and Comparative Example 1 as a function of current.

### MODE FOR INVENTION

The present invention provides an electrode catalyst including a carbon support and a metal catalyst supported on the carbon support wherein a thermally responsive polymer is selectively bound to the carbon support.

The thermally responsive polymer refers to a material that becomes hydrophilic at or below a predetermined temperature, for example, a non-operating temperature of a fuel cell, and becomes hydrophobic at or above a predetermined temperature, for example, an operating temperature of the fuel cell. The non-operating temperature may be not higher than 40° C. or 32° C. and the operating temperature may be not lower than 60° C. or around about 70° C. Taking advantage of the temperature-dependent physical properties of the thermally responsive polymer, the electrode catalyst of the present invention can suppress the occurrence of flooding in a fuel cell.

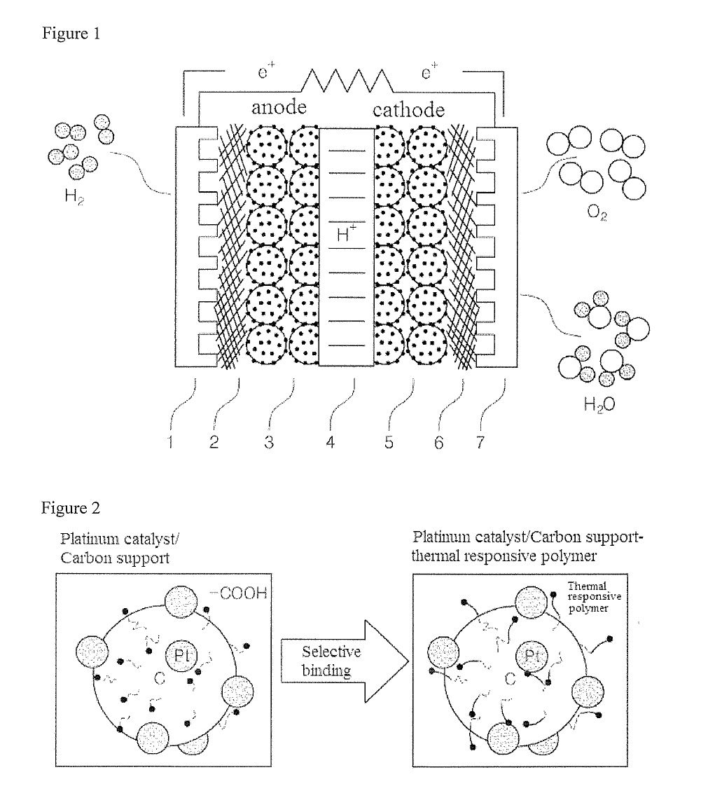

FIG. 1 is a schematic diagram showing an operating mechanism of a general fuel cell. As shown in FIG. 1, the fuel cell includes current collectors 1 and 7, gas diffusion layers (GDLs) 2 and 6, catalyst layers 3 and 5, and an electrolyte membrane 4. Hydrogen gas as a fuel and oxygen gas (or air) are injected into an anode and a cathode, respectively. The gases are allowed to flow into the electrodes at constant rates. The hydrogen gas molecules injected through the current collector 1 are diffused through the gas diffusion layer 2 and are supplied to the catalyst layer 3. The supplied hydrogen gas comes into contact with catalyst particles present in the catalyst layer 3 and is subjected to an electrochemical reaction under the influence of a platinum catalyst adsorbed on the surface of a carbon support constituting the catalyst particles. That is, in the catalyst layer 3 of the anode serving as an oxidation layer, the following reaction takes place: H₂ (g)→2H⁺+2e⁻. The protons (H⁺) are transferred to the catalyst layer 5 of the cathode serving as a reduction layer through the electrolyte membrane 4, and the electrons (e) are transferred through an external electric wire.

In the catalyst layer 5 of the cathode serving as a reduction layer, the transferred protons and electrons react with oxygen to produce water (H₂O) as follows: ½O₂ (g)+2H⁺+2e⁻→H₂O. The water thus produced is discharged from the catalyst layer 5 of the cathode to the outside through the gas diffusion layer 6 and the current collector 7, or is accumulated in the cathode. This reaction is exothermic and the temperature of the fuel cell is increased, for example, to 50° C. or above, during operation.

In the electrode catalyst of the present invention, the metal catalyst is selectively bound to the surface of the carbon support constituting the catalyst particles included in the catalyst layer 5 of the cathode. This binding is exemplified in FIG. 2. As shown in FIG. 2, a carboxyl group present on the surface of the carbon support react with a terminal amine group of the thermally responsive polymer to form an amide bond (—C(═O)—NH—). As a result of the reaction, the thermally responsive polymer is selectively bound to the carbon support. The metal catalyst supported on the carbon support does not react with the thermally responsive polymer due to the absence of surface carboxyl group.

Since the thermally responsive polymer is selectively bound to the surface of the carbon support, heat generated during operation of a fuel cell varies the physical properties of the electrode catalyst, rendering the electrode catalyst hydrophobic. The hydrophobicity of the electrode catalyst enables effective discharge of water produced in the cathode, and as a result, the occurrence of flooding in the cathode can be suppressed, resulting in an improvement in the performance of the fuel cell.

That is, as described above, the thermally responsive polymer is selectively bound to the carbon support in the catalyst by chemical binding but is not bound to the metal catalyst (e.g., a platinum catalyst) supported on the carbon support. This selective binding causes no reduction in the active surface area of the catalyst and makes the surface of the electrode catalyst particles hydrophilic at a low non-operating temperature of the fuel cell. This hydrophilicity suppresses agglomeration of the particles during catalyst dispersion. When the fuel cell is operated, hydrophobicity is imparted to the electrode catalyst to ensure efficient discharge of water, resulting in an increase in mass transfer. As a result, the occurrence of flooding in the electrode can be suppressed, leading to an improvement in the performance of the fuel cell.

As a thermally responsive polymer selectively bound to the carbon support, any material can be used if it becomes hydrophilic at a low non-operating temperature of a fuel cell and becomes hydrophobic at a high operating temperature of the fuel cell. For example, the thermally responsive polymer may be a polymer including a repeating unit of Formula 1:

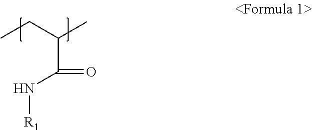

wherein R₁ represents a hydrogen atom, a halogen atom, a hydroxyl group, a substituted or unsubstituted C₁-C₂₀ alkyl group, a substituted or unsubstituted C₆-C₃₀ aryl group, a substituted or unsubstituted C₁-C₂₀ heteroalkyl group, a substituted or unsubstituted C₅-C₃₀ heteroaryl group, or a substituted or unsubstituted C₇-C₃₀ arylalkyl group.

According to one exemplary embodiment, the repeating unit of Formula 1 may be represented by Formula 2:

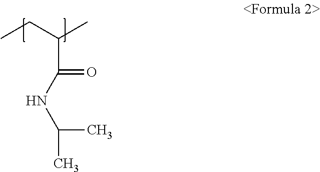

The thermally responsive polymer including the repeating unit of Formula 1 or 2 may be exemplified by poly(N-isopropylacrylamide) (PNIPAM) of Formula 3:

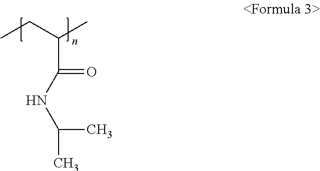

wherein n is a number from 10 to 100,000.

In Formula 3, the degree of polymerization n of the polymer may be, for example, in the range of 10 to 10,000 or 10 to 1,000.

Generally, the poly(N-isopropylacrylamide) is hydrophilic at a temperature not higher than about 32° C. and is hydrophobic at a temperature not lower than about 32° C. Thus, the hydrophilic poly(N-isopropylacrylamide) at a non-operating temperature of a fuel cell can suppress agglomeration of the particles during catalyst dispersion. When the fuel cell is operated, the hydrophilic poly(N-isopropylacrylamide) imparts hydrophobicity to the electrode catalyst to ensure efficient discharge of water.

The selective binding between the carbon support and the thermally responsive polymer may be accomplished, for example, by chemical binding. The chemical binding may be exemplified by amide bonding. That is, the selective binding can be enabled through chemical binding between the carboxyl group present on the surface of the carbon support and the terminal amine group of the thermally responsive polymer. This reaction may be carried out in an acidic solution in the absence or presence of a catalyst. As the catalyst, there may be used, for example, 1-ethyl-3-(3-dimethylaminopropyl)carbodiimide (EDC).

The electrode catalyst including the selectively bound thermally responsive polymer has a basic structure in which the metal catalyst is supported on the carbon support as a catalyst support. Any catalytically active material that is generally used in the art may be used without particular limitation as the metal catalyst. For example, the metal catalyst may be a platinum catalyst. The platinum catalyst is advantageous for efficient electricity generation of a fuel cell.

The platinum catalyst may be any of those that can be used in the art. The platinum catalyst may include at least one metal selected from the group consisting of, but not limited to, platinum (Pt), palladium (Pd), ruthenium (Ru), iridium (Ir), osmium (Os), platinum-palladium (Pt—Pd) alloys, platinum-ruthenium (Pt—Ru) alloys, platinum-iridium (Pt—Ir) alloys, platinum-osmium (Pt—Os) alloys, and platinum (Pt)-M alloys (where M is gallium (Ga), titanium (Ti), vanadium (V), chromium (Cr), manganese (Mn), iron (Fe), cobalt (Co), nickel (Ni), copper (Cu), silver (Ag), gold (Au), zinc (Zn), tin (Sn), molybdenum (Mo), tungsten (W), and rhodium (Rh)).

The platinum catalyst may be in the form of nanoparticles with an average diameter of 10 nm or less. In this case, the surface area of the particles is large enough to ensure sufficient activity of the catalyst. For example, the average diameter of the platinum catalyst particles may be from 2 nm to 10 nm.

The metal catalyst is supported on a catalyst support. The catalyst support may be any suitable support material that can support the metal catalyst. The catalyst support is preferably made of a carbon material. The carbon support may include at least one carbon material selected from the group consisting of carbon powder, carbon black, acetylene black, ketjen black, active carbon, carbon nanotube, carbon nanofiber, carbon nanowire, carbon nanohorn, carbon aerogel, carbon cryogel, and carbon nanoring. The average diameter of the carbon support may be in the range of 20 nm to 50 nm but is not limited to this range.

The carbon-supported platinum catalyst may be any commercially available material or may be directly prepared by supporting the platinum catalyst on the carbon support. The process for supporting the catalyst is widely known in the art and will be easily understood by those skilled in the art. Thus, a detailed description of the process is omitted herein.

Small-sized pores may be formed in the electrode catalyst. For example, pores having an average diameter of 100 nm or less may account for 30% by volume or more based on the total pore volume of the catalyst.

The pore size is determined by the inherent physical properties of the catalyst. That is, the pore size is determined taking into account the inherent physical properties of the catalyst other than the size, specific surface area, and surface characteristics of the catalyst particles. The average diameter of the pores can be measured by various methods generally known in the art, for example, optical microscopy, electron microscopy, X-ray scattering, gas-adsorption, mercury intrusion, liquid extrusion, molecular weight cut off method, fluid displacement method, and measurement using pulsed NMR.

In another aspect, the present invention provides a membrane electrode assembly including a cathode, an anode arranged opposite the cathode, and an electrolyte membrane arranged between the cathode and the anode wherein the cathode includes the electrode catalyst.

In yet another aspect, the present invention provides a fuel cell including the membrane electrode assembly.

The fuel cell may be, for example, a polymer electrolyte membrane fuel cell (PEMFC), a phosphoric acid fuel cell (PAFC), or a direct methanol fuel cell (DMFC).

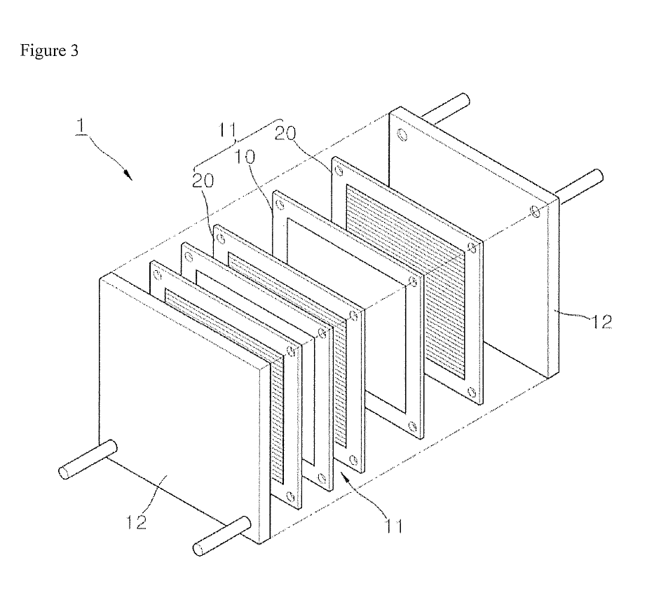

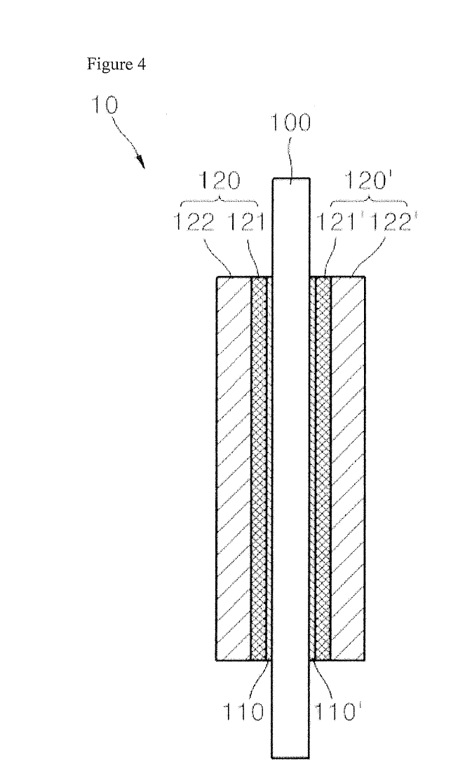

FIG. 3 is an exploded perspective view illustrating one embodiment of the fuel cell and FIG. 4 is a schematic cross-sectional view of a membrane electrode assembly (MEA) constituting the fuel cell of FIG. 3.

In the fuel cell 1 schematically illustrated in FIG. 3, two unit cells 11 are sandwiched between a pair of holders 12 and 22. Each of the unit cells 11 includes a membrane electrode assembly 10 and bipolar plates 20 arranged at both sides of the membrane electrode assembly 10 in the thickness direction thereof. The bipolar plates 20 are made of a conductive metal or carbon and are attached to the membrane electrode assembly 10. Due to this construction, the bipolar plates 20 supply oxygen and fuel to catalyst layers of the membrane electrode assembly 10 while functioning as current collectors.

The number of the unit cells 11 in the fuel cell 1 is not limited. Although FIG. 3 illustrates two unit cells 11 in the fuel cell 1, a larger number of unit cells may also be provided. For example, several ten to several hundred unit cells may be provided depending on the required characteristics of the fuel cell.

As illustrated in FIG. 4, the membrane electrode assembly 10 includes an electrolyte membrane 100, catalyst layers 110 and 110′ arranged at both sides of the electrolyte membrane 100 in the thickness direction, and gas diffusion layers 120 and 120 laminating the catalyst layers 110 and 110′, respectively. The gas diffusion layers 120 and 120′ include microporous layers 121 and 121′ and supports 122 and 122′, respectively.

The gas diffusion layers 120 and 120′ serve to diffuse oxygen and fuel supplied through the bipolar plates 20 into the overall surfaces of the catalyst layers 110 and 110′, respectively. The gas diffusion layers 120 and 120′ are advantageously porous so that water produced in the catalyst layers 110 and 110′ can be rapidly discharged to the outside and the air can be smoothly flowed. The gas diffusion layers 120 and 120′ are required to be electrically conductive so that an electric current generated in the catalyst layers 110 and 110′ can be transferred.

The supports 122 and 122′ of the gas diffusion layers 120 and 120′ may be made of an electrically conductive material such as a metal or carbon material. Examples of the supports 122 and 122′ include, but are not limited to, conductive substrates such as carbon papers, carbon cloths, carbon felts, and metal cloths.

The microporous layers 121 and 121′ may typically include a conductive powder having a small particle diameter, for example, carbon powder, carbon black, acetylene black, active carbon, carbon fiber, fullerene, carbon nanotube, carbon nanowire, carbon nanohorn or carbon nanoring.

If the particles of the conductive powder constituting the microporous layers 121 and 121′ are too small in size, a severe pressure may occur, causing insufficient gas diffusion. Meanwhile, if the particles of the conductive powder are excessively large in size, uniform gas diffusion may be difficult to take place. Taking into consideration the effective gas diffusion, the average particle diameter of the conductive powder is generally limited to the range of 10 nm to 50 nm.

The gas diffusion layers 120 and 120′ may be commercially available products or may be directly prepared by coating microporous layers 121 and 121′ on commercial carbon papers. In the microporous layers 121 and 121′, gases are diffused through pores formed between the particles of the conductive powder. The average pore size is not particularly limited and may be, for example, in the range of 1 nm to 10 μm, 5 μm to 10 nm to 500 nm, or 50 nm to 400 nm.

The thickness of each of the gas diffusion layers 120 and 120′ may be determined within the range of 200 μm to 400 μm taking into consideration various factors such as gas diffusion and the electrical resistance. For example, the thickness of the gas diffusion layers 120 and 120′ may be from 100 μm to 350 μm, more specifically, from 200 μm to 350 μm.

For example, the catalyst layers 110 and 110′ function as a fuel electrode (an anode) and an oxygen electrode (a cathode). Each of the catalyst layers 110 and 110′ includes an electrode catalyst and a binder. Each of the catalyst layers 110 and 110′ may further include a material capable of increasing the electrochemical surface area of the electrode catalyst. The electrode catalyst has been already described above, and thus a detailed explanation thereof is omitted herein.

The thickness of each of the catalyst layers 110 and 110′ may be in the range of 10 μm to 100 μm. Within this range, effective activation of the electrode reaction can be ensured and an excessive increase in electrical resistance can be prevented. For example, the thickness of each of the catalyst layers 110 and 110′ may be in the range of 20 μm to 60 μm, more specifically, 30 μm to 50 μm.

Each of the catalyst layers 110 and 110′ may further include a binder resin to achieve its improved adhesive strength and hydrogen ion transfer. The binder resin is preferably a proton-conducting polymer resin and is more preferably a polymer resin whose side chains have cation exchange groups selected from the group consisting of sulfonic acid groups, carboxylic acid groups, phosphoric acid groups, phosphonic acid groups, and derivatives thereof. Preferably, the binder resin may include at least one proton-conducting polymer selected from fluorinated polymers, benzimidazole polymers, polyimides, polyether imides, polyphenylene sulfides, polysulfones, polyether sulfones, polyether ketones, polyether-ether ketones, and polyphenylquinoxalines.

The catalyst layers 110 and 110′, the microporous layers 121 and 121′, and the supports 122 and 122′ may be arranged adjacent to each other and other functional layers may also be inserted therebetween, if needed. These layers constitute the cathode and anode of the membrane electrode assembly.

The electrolyte membrane 100 is arranged in contact with the catalyst layers 110 and 110′. A material for the electrolyte membrane is not particularly limited. For example, the electrolyte membrane may be made of at least one polymer selected from the group consisting of polybenzimidazole (PBI), cross-linked polybenzimidazole, poly(2,5-benzimidazole)(ABPBI), polyurethane, and modified polytetrafluoroethylene (PTFE).

The electrolyte membrane 100 is impregnated with phosphoric acid or an organic phosphoric acid. Other acids may also be used instead of phosphoric acid. For example, the electrolyte membrane 100 may be impregnated with a phosphoric acid-based material such as polyphosphoric acid, phosphonic acid (H₃PO₃), orthophosphoric acid (H₃PO₄), pyrophosphoric acid (H₄P₂O₇), triphosphoric acid (H₅P₃O₁₀), metaphosphoric acid, or a derivative thereof. The concentration of the phosphoric acid-based material is not particularly limited and may be at least 80% by weight, 90% by weight, 95% by weight or 98% by weight. For example, an 80 to 100% by weight aqueous solution of phosphoric acid may be used.

The membrane electrode assembly can ensure efficient discharge of water from the cathode, contributing to high cell performance, when compared to conventional membrane electrode assemblies using general catalyst layers.

The fuel cell of the present invention can be operated at a temperature of 60° C. to 300° C. As illustrated in FIG. 3, a fuel (for example, hydrogen) may be supplied to one of the catalyst layers through the bipolar plate 20 and an oxidizing agent (for example, oxygen) may be supplied to the other catalyst layer through the opposite bipolar plate 20. The hydrogen is oxidized in a catalyst layer to produce hydrogen ions (H⁺). The hydrogen ions are conducted across the electrolyte membrane 100 and reach the opposite catalyst layer where they electrochemically react with oxygen to produce water (H₂O) and generate electrical energy. The hydrogen supplied as the fuel may be obtained by modification of a hydrocarbon or alcohol. Air containing oxygen may be supplied as the oxidizing agent.

The present invention will be explained with reference to the following examples. However, these examples are not intended to limit the scope of the present invention.

### Example 1

### Synthesis of Pt/C-PNIPAM

Pt/C (40 wt %, Johnson Matthey) was dispersed with amine-terminated PNIPAM (Aldrich) represented by Formula 4 in an acidic solution with pH 1.6, which was composed of 300 mL of isopropyl alcohol (IPA, Aldrich) and 0.6 mL of HC1O₄ (Aldrich). After the solution was mixed with stirring for 1 h, 1-ethyl-3-(3-dimethylaminopropyl)carbodiimide (EDC, Fluka) was introduced as a catalyst into the stifled solution for the amide reaction between —COOH of the carbon surface and —NH₂ of amine-terminated PNIPAM. The solution was washed through the filtration by excessive deionized (DI) water after the amide reaction by EDC for 12 h. The filtered Pt/C-PNIPAM was dried at 60° C., and Pt/C-PNIPAM powder was finally ground in a mortar.

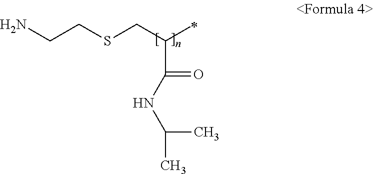

wherein n is a number of 25.

### Example 2

### Membrane Electrode Assembly (MEA) Preparation

In this example, a membrane electrode assembly was prepared with PNIPAM in the cathode.

A catalyst ink for the cathode catalyst layer with PNIPAM was prepared by mixing 6.3 mg of Pt/C-PNIPAM, Nafion ionomer solution (Aldrich) (N/C ratio of 0.5), and IPA (0.63 mL) Nafion 212 membranes (DuPont) were used after the pretreatment. The catalyst ink was boiled in 3% hydrogen peroxide solution, and rinsed in DI water. After that, the catalyst ink was soaked in 0.5 M H₂SO₄, and washed again in DI water. Each procedure in the solution was performed at 80° C. for 1 h. The prepared catalyst ink was sprayed onto the anode and cathode parts of the Nafion 212 membrane.

The catalyst-coated membrane was dried at room temperature for 12 h, and sandwiched between the anode and cathode gas diffusion layers (SGL 35 BC) without application of the hot-press process. The active geometric area of the MEA was 5 cm².

### Comparative Example 1

### Membrane Electrode Assembly (MEA) Preparation

In this example, a membrane electrode assembly was prepared without PNIPAM in the cathode.

A catalyst ink for the cathode catalyst layer with PNIPAM was prepared by mixing 6.3 mg of nontreated 40 wt % Pt/C, Nafion ionomer solution (Aldrich) (N/C ratio of 0.5), and IPA (0.63 mL). Nafion 212 membranes (Dupont) were used after the pretreatment. The catalyst ink was boiled in 3% hydrogen peroxide solution, and rinsed in DI water. After that, the catalyst ink was soaked in 0.5 M H₂SO₄, and washed again in DI water. Each procedure in the solution was performed at 80° C. for 1 h. The prepared catalyst ink was sprayed onto the anode and cathode parts of the Nation 212 membrane.

The catalyst-coated membrane was dried at room temperature for 12 h, and sandwiched between the anode and cathode gas diffusion layers (SGL 35 BC) without the application of the hot-press process. The active geometric area of the MEA was 5 cm².

Experimental Example 1

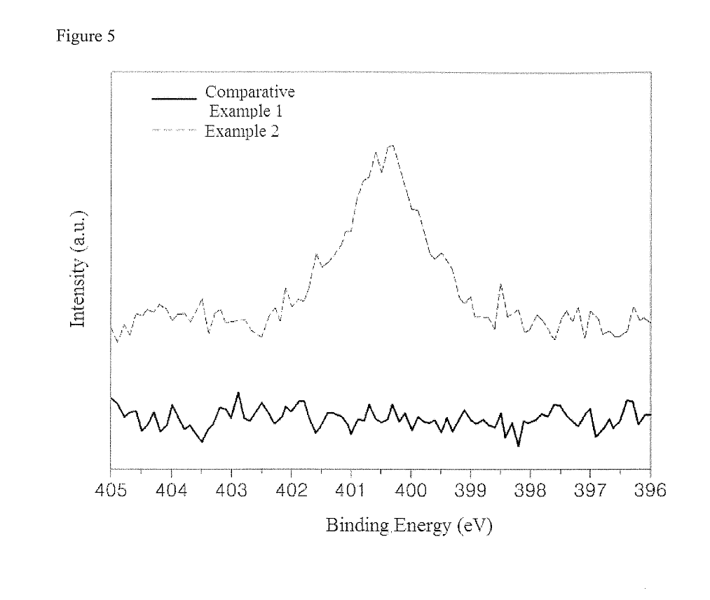

For the unit cells prepared in Example 2 and Comparative Example 1, each catalyst surface was analyzed by X-ray photoelectron spectroscopy (XPS). The results are shown in FIG. 5.

As can be seen from the results of FIG. 5, the existence of the N 1s peak at 400.5 eV of Pt/C-PNIPAM contained in the catalyst layer of Example 2 shows that PNIPAM was definitely located on Pt/C, and the amide bond was formed between the carbon surface and PNIPAM. In addition, it was confirmed that PNIPAM was selectively bound only to the carbon surfaces without affecting Pt surfaces.

Experimental Example 2

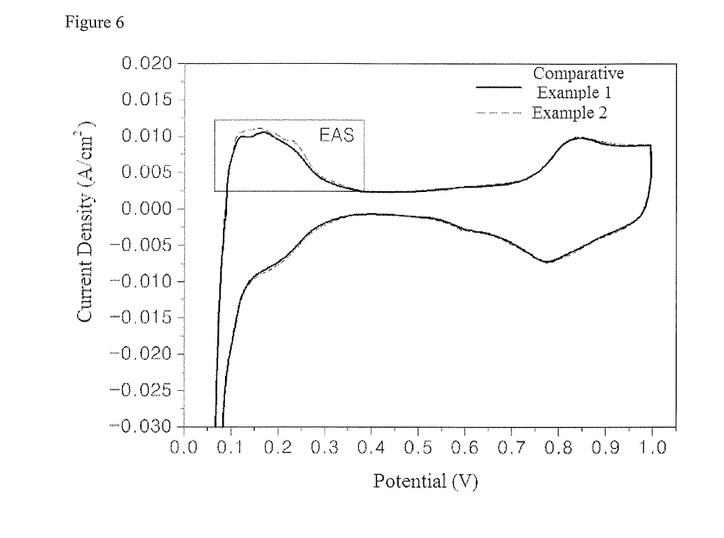

Cyclic voltammetry (CV) scans were obtained at 100 mV/s between 0.05 V and 1.0 V to compare the electrochemical active surfaces (EAS) of the cathode catalyst layers prepared in Example 2 and Comparative Example 1 (FIG. 6).

Humidified H2 (50 mL/min) and N₂ (200 mL/min) were supplied to the anode and cathode, respectively, and the unit cell was operated at 150° C. and 100% relative humidity.

As shown in FIG. 6, cyclic voltammetry (CV) scans of the cathode catalyst layers were similar to each other in overall potential region, and the EAS of Pt/C-PNIPAM was comparable to that of Pt/C. Based on these observations, it was concluded that PNIPAM did not attach to platinum nanoparticles and hardly affected the electronic structure of Pt catalyst.

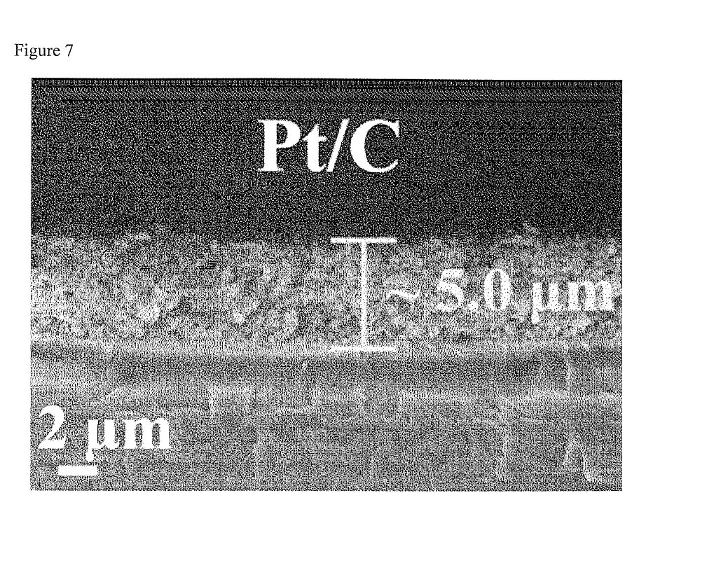

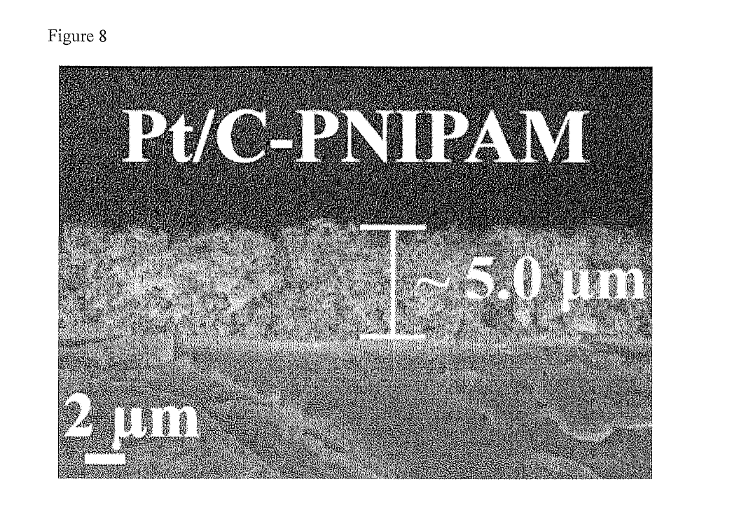

FIGS. 7 and 8 are SEM images of the catalyst layers obtained in Comparative Example 1 and Example 2, respectively. The SEM images show similar thickness in the catalyst layer of Pt/C and Pt/C-PNIPAM, indicating that the catalyst layers had similar structure and particle dispersion. It means that Pt/C-PNIPAM with hydrophilic surface could be well dispersed in the catalyst ink at room temperature.

Experimental Example 3

To elucidate the fuel cell performance depending on the cell temperature, the MEAs prepared in Example 2 and Comparative Example 1 were tested at 10, 25, 30, 40, and 50° C. in the same manner as in Experimental Example 2.

The unit cell was surrounded by several ice packs to decrease the cell temperatures. When the cell temperature went down to the desired temperature, the performance test was started with keeping the temperature by the heating rods in the unit cell.

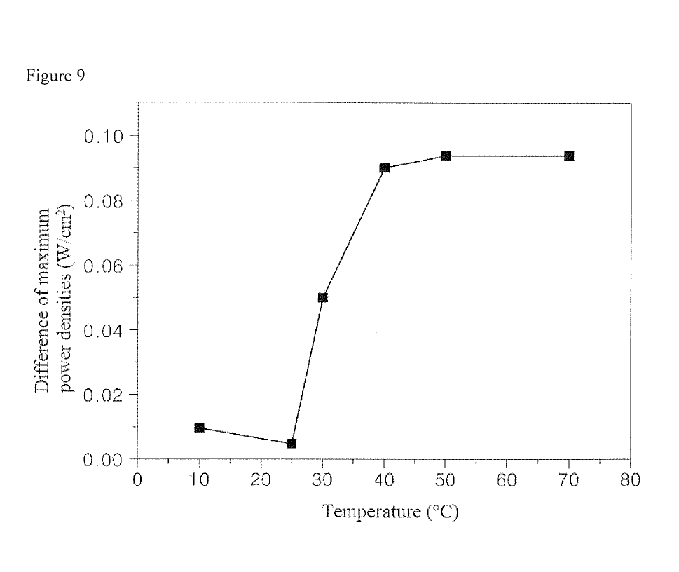

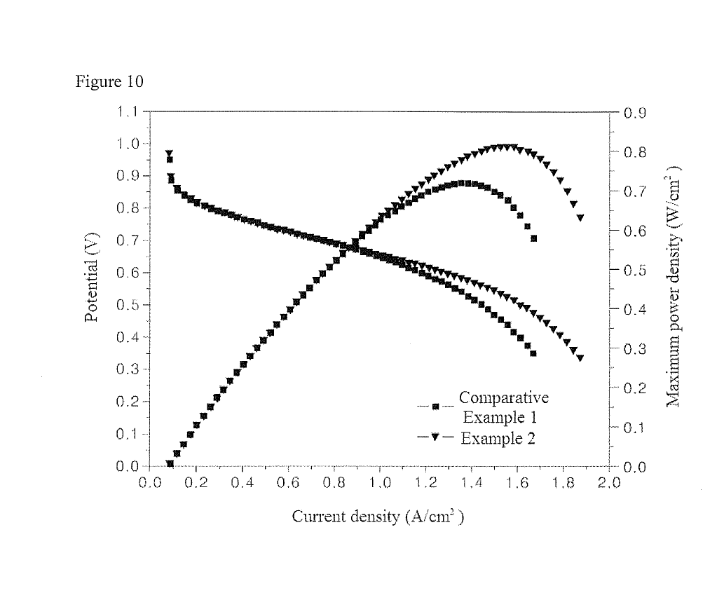

The differences of maximum power densities depending on the cell temperatures are shown in FIG. 9, and current-voltage relations are shown in FIG. 10.

As shown in FIG. 9, the differences were insignificant at temperatures of <30° C., since the hydrophilicity of the cathode with Pt/C-PNIPAM was similar to that with Pt/C at low temperature. However, the hydropohilicity gap between Pt/C-PNIPAM and Pt/C were considerably increased by ˜0.10 W/cm² at temperatures of >30° C., because of the change in the hydrophilicity on carbon surfaces of Pt/C-PNIPAM. Therefore, it was concluded that PNIPAM on carbon surfaces of Pt/C-PNIPAM played a pivotal role in water discharge in the cathode.

As can be seen from the current-potential graph shown in FIG. 10, there was no substantial difference in the performance of the cells of Example 2 and Comparative Example 1 in the potential region above 0.7 V but the cell of Example 2 showed improved cell performance, resulting from increased mass transfer, in the potential region below 0.7 Vat which flooding occurs.

1. An electrode catalyst comprising a carbon support and a metal catalyst supported on the carbon support wherein a thermally responsive polymer is selectively bound to the carbon support.

2. The electrode catalyst according to claim 1, wherein the thermally responsive polymer becomes hydrophobic at or above a predetermined temperature and becomes hydrophilic at or below the predetermined temperature.

3. The electrode catalyst according to claim 1, wherein the thermally responsive polymer comprises a repeating unit of Formula 1: 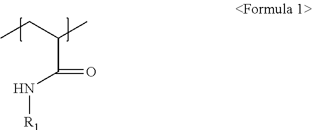
wherein R₁ represents a hydrogen atom, a halogen atom, a hydroxyl group, a substituted or unsubstituted C₁-C₂₀ alkyl group, a substituted or unsubstituted C₆-C₃₀ aryl group, a substituted or unsubstituted C₁-C₂₀heteroalkyl group, a substituted or unsubstituted C₅-C₃₀heteroaryl group, or a substituted or unsubstituted C₇-C₃₀arylalkyl group.

4. The electrode catalyst according to claim 1, wherein the thermally responsive polymer comprises the repeating unit of Formula 2:

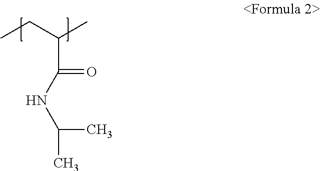

5. The electrode catalyst according to claim 1, wherein the thermally responsive polymer is poly(N-isopropyl acrylamide) of Formula 3: 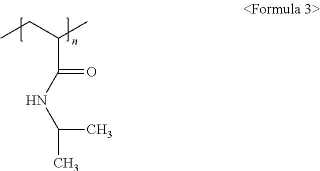
wherein n is a number from 10 to 100,000.

6. The electrode catalyst according to claim 1, wherein the metal catalyst is a platinum catalyst.

7. A method for preparing the electrode catalyst for a fuel cell according to claim 1, comprising
mixing a thermally responsive amine-terminated polymer with a metal catalyst supported on a carbon support in an acidic solution, and
reacting the carbon support with the thermally responsive polymer in the presence of a catalyst to form an amide bond.

8. A membrane electrode assembly comprising
a cathode,
an anode arranged opposite the cathode, and
an electrolyte membrane arranged between the cathode and the anode
wherein the cathode comprises the electrode catalyst according to claim 1.

9. A fuel cell comprising the membrane electrode assembly according to claim 8.

10. The fuel cell according to claim 9, wherein the thermally responsive polymer present in the membrane electrode assembly becomes hydrophobic at an operating temperature of the fuel cell and becomes hydrophilic at a non-operating temperature of the fuel cell.
